(19) United States
(12) Patent Application Publication
(10) Pub. No.: US 2010/0157477 A1
(43) Pub. Date: Jun. 24, 2010

(54) THIN-FILM MAGNETIC-RECORDING HEAD INCLUDING BUILT-IN ACOUSTIC-EMISSION SENSOR

(76) Inventors: Akira MORINAGA, Kanagawa (JP); Masanori Tanabe, Kanagawa (JP)

Correspondence Address: HITACHI C/O WAGNER BLECHER LLP, 123 WESTRIDGE DRIVE, WATSONVILLE, CA, 95076, US

(21) Appl. No.: 12/642,660

(22) Filed: Dec. 18, 2009

(30) Foreign Application Priority Data
Dec. 18, 2008 (JP) 2008-322225

(51) Int. Cl. G11B 5/127

(52) U.S. Cl. 360/125.12; G9B/5.04

(57) ABSTRACT

A thin-film magnetic-recording head. The thin-film magnetic-recording head includes a read/write element portion, at least one built-in thin-film acoustic-emission sensor, and a heater. The read/write element portion, the thin-film acoustic-emission sensor and the heater are integrally formed in proximity to a face of an electrically conductive slider substrate over which the read/write element portion, the acoustic-emission sensor and the heater are formed, near an air-bearing surface formed on a surface of the slider substrate. The face of the slider substrate is configured to be disposed opposite to a magnetic-recording medium of a magnetic-recording disk.

### CROSS-REFERENCE TO RELATED APPLICATION

This application claims priority from the Japanese Patent Application No. 2008-322225, filed Dec. 18, 2008, the disclosure of which is incorporated herein in its entirety by reference.

### TECHNICAL FIELD

Embodiments of the present invention relate to thin-film magnetic-recording heads, including an acoustic-emission (AE) sensor, for hard-disk drives (HDDs).

### BACKGROUND

As is known in the art, a HDD includes a magnetic-recording disk, which includes a magnetic-recording medium, and a magnetic-recording head for writing data to, and reading data from, the magnetic-recording medium. Surface flatness and smoothness of the surface of the magnetic-recording disk are maintained within tight tolerances to provide the nano-scale fly heights utilized in high-density magnetic-recording technology. Therefore, surface flatness and smoothness checks of the surface of the magnetic-recording disk, referred to by the term of art, “glide tests,” are performed for detecting surface roughness and unusual protrusions on the surface of the magnetic-recording disk.

Engineers and scientists engaged in high-density magnetic-recording technology development are interested in the design of HDDs that control the fly height and variations in the fly height between the magnetic-recording head and the magnetic-recording disk to meet the rising demands of the marketplace for increased data-storage capacity, performance, and reliability.

### SUMMARY

Embodiments of the present invention include a thin-film magnetic-recording head. The thin-film magnetic-recording head includes a read/write element portion, at least one built-in thin-film acoustic-emission sensor, and a heater. The read/write element portion, the thin-film acoustic-emission sensor and the heater are integrally formed in proximity to a face of an electrically conductive slider substrate over which the read/write element portion, the acoustic-emission sensor and the heater are formed, near an air-bearing surface formed on a surface of the slider substrate. The face of the slider substrate is configured to be disposed opposite to a magnetic-recording medium of a magnetic-recording disk.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a first schematic cross-sectional view of an acoustic-emission (AE) sensor, heater, and thin-film magnetic-recording head element region at a neighboring section of an air-bearing surface (ABS) for a slider, in accordance with an embodiment of the present invention.

FIG. 2 is a first schematic diagram that represents a flying slider and AE propagation during contact with a magnetic-recording disk, in accordance with an embodiment of the present invention.

FIG. 3 is a schematic diagram showing an example of layout of the thin-film AE sensor, heater, thin-film magnetic-recording head element region, and electrode pads, in accordance with an embodiment of the present invention.

FIG. 4 is a schematic diagram, showing the layout of the thin-film AE sensor, heater, and electrode pads, in accordance with an embodiment of the present invention.

FIG. 5 is another schematic diagram in continuation, showing the layout of the thin-film AE sensor, heater, and electrode pads, in accordance with an embodiment of the present invention.

FIG. 6 is yet another schematic diagram in continuation, showing the layout of the thin-film AE sensor, heater, and electrode pads, in accordance with an embodiment of the present invention.

FIG. 7 is a further schematic diagram in continuation, showing the layout of the thin-film AE sensor, heater, and electrode pads, in accordance with an embodiment of the present invention.

FIG. 8 is a further schematic diagram in continuation, showing the layout of the thin-film AE sensor, heater, and electrode pads, in accordance with an embodiment of the present invention.

FIG. 9 is a second schematic cross-sectional view of the AE sensor, heater, and thin-film magnetic-recording head element region at the neighboring section of the ABS for the slider, in accordance with an embodiment of the present invention.

FIG. 10 is a second schematic diagram that represents a flying slider and AE propagation during contact with the magnetic-recording disk, in accordance with an embodiment of the present invention.

FIGS. 11(a), 11(b) and 11(c) are schematic views showing an example of a layout of wafer substrates in a wafer each including a thin-film AE sensor previously deposited thereupon, in accordance with an embodiment of the present invention.

FIGS. 12(a), 12(b) and 12(c) are schematic diagrams showing a manufacturing process for a thin-film magnetic-recording head which uses the wafer substrate having a previously deposited thin-film AE sensor, in accordance with an embodiment of the present invention.

FIGS. 13(a) and 13(b) are schematic diagrams showing the manufacturing process for the thin-film AE sensor, in accordance with an embodiment of the present invention.

FIGS. 14(a) and 14(b) are other schematic diagrams in continuation showing the manufacturing process for the thin-film AE sensor, in accordance with an embodiment of the present invention.

FIG. 15 is yet another schematic diagram in continuation showing the manufacturing process for the thin-film AE sensor, in accordance with an embodiment of the present invention.

FIG. 16 is a further schematic diagram in continuation showing the manufacturing process for the thin-film AE sensor, in accordance with an embodiment of the present invention.

FIG. 17 is a further schematic diagram in continuation showing the manufacturing process for the thin-film AE sensor, in accordance with an embodiment of the present invention.

FIG. 18 is a further schematic diagram in continuation showing the manufacturing process for the thin-film AE sensor, in accordance with an embodiment of the present invention.

FIG. 19 is a further schematic diagram in continuation, showing the manufacturing process for the thin-film AE sensor, in accordance with an embodiment of the present invention.

FIG. 20 is a schematic view showing an example of connecting two thin-film AE sensors, also showing a heater and thin-film magnetic-recording head element region present near an ABS, in accordance with an embodiment of the present invention.

FIG. 21 is a schematic view in continuation showing the example of connecting two thin-film AE sensors, and also showing the heater and thin-film magnetic-recording head element region present near the ABS, in accordance with an embodiment of the present invention.

FIG. 22 is another schematic view in continuation showing the example of connecting two thin-film AE sensors, and also showing the heater and thin-film magnetic-recording head element region present near the ABS, in accordance with an embodiment of the present invention.

FIG. 23 is a diagram showing an example of forming two thin-film AE sensors near an outer edge of a slider, in accordance with an embodiment of the present invention.

FIG. 24 is a diagram showing an example of detecting unusual slider contact, in accordance with an embodiment of the present invention.

FIG. 25 is a schematic view of a conventional HDD.

FIG. 26 is a schematic layout view of a conventional thin-film magnetic-recording head element region.

FIG. 27 is another schematic layout view of the conventional thin-film magnetic-recording head and heater element region.

FIG. 28 is a schematic cross-sectional view of the conventional thin-film magnetic-recording head and heater element region.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### Description of Embodiments of the Present Invention for a Thin-Film Magnetic-Recording Head Including a Built-in Acoustic-Emission Sensor

Embodiments of the present invention include thin-film magnetic-recording heads for hard-disk drives (HDDs), each of the magnetic-recording heads being constructed to include a slider substrate formed from an electrically conductive material, a heater element used for control of fly height, and a read/write element portion. As used herein, the term of art, “electroconductive,” is identified with the term of art, “electrically conductive.” More particularly, the invention concerns a thin-film magnetic-recording head in which an acoustic-emission (AE) sensor including a piezoelectric element is formed on the slider substrate. As used herein, the terms of art, “slider,” “slider substrate,” and “head-slider,” are used interchangeably. This magnetic-recording head is constructed to use the AE sensor to detect contact between the head-slider and a magnetic-recording medium disposed opposite to the head-slider when the head-slider flies in proximity with the magnetic-recording medium of a magnetic-recording disk in a HDD. The magnetic-recording head is further constructed to use the heater element to control the fly height of the slider between the read/write element portion of the magnetic-recording head disposed in the head-slider and the magnetic-recording medium at about a constant value with the position of the above-described contact, referred to herein as a “contact position,” taken as a starting point of the control.

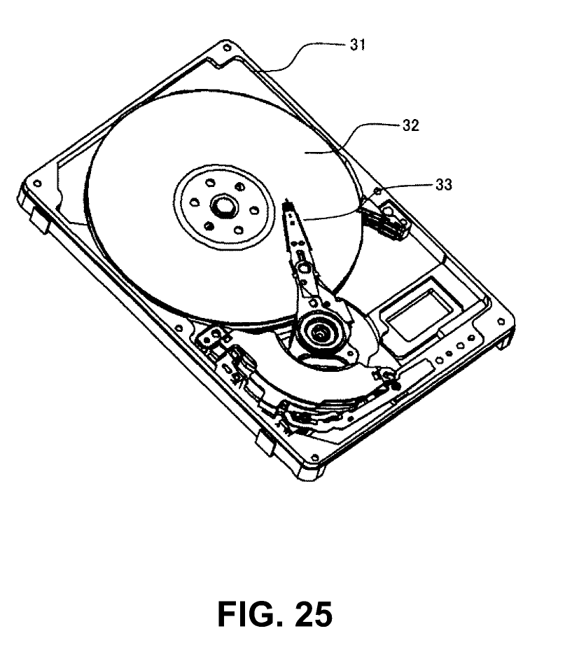

With reference now to FIG. 25, with relevance for embodiments of the present invention, a schematic overview is shown of a HDD. As shown in FIG. 25, a magnetic-recording disk 32 that includes the magnetic-recording medium, and a head-arm assembly (HAA) 33 for writing data to, and reading data from, the magnetic-recording medium are used as major components in a disk enclosure (DE) 31 of the HDD, which also includes a signal-processing circuit and a mechanical driving mechanism as components.

Surface flatness and smoothness of the magnetic-recording medium are included as design considerations for enhanced HDD performance. Surface flatness and smoothness checks of the magnetic-recording medium, that is, glide-height tests for detecting surface roughness and unusual protrusions are performed. For example, as is known in the art, contact of a slider with respect to the magnetic-recording medium can be detected by affixing a piezoelectric element to the slider and reading any changes in the voltage of the piezoelectric element. However, known schemes for affixing the piezoelectric element from the outside to the surface of the slider, raises number of issues, considering the possible nonuniformity of characteristics between piezoelectric elements and the machine cycle time required for the attaching operation. In addition, the piezoelectric element itself may possibly peel away from the surface of the slider. Accordingly, in the alternative, a method of forming the piezoelectric element integrally upon an insulating substrate is known in the art.

In addition, to increasing the recording densities of the magnetic-recording heads/recording media which are components of the HDD, the read/write characteristics represented by output capabilities, error rates, and similar HDD performance metrics have also advanced in concert with the advance of HDD technology. The read/write characteristics strongly depend upon fly height of a particular magnetic-recording head flown in proximity with an associated magnetic-recording medium. To increase the read/write characteristics for increased recording density of the HDD, the fly height is set at a constant value for each magnetic-recording head, and is also reduced to a minimum level that is still consistent with maintaining reliability.

Even if individual sliders are of the same design, the absolute fly heights of each single slider differ since the behavior of the slider depends upon the workmanship of the air-bearing surface (ABS) juxtaposed to the magnetic-recording medium. Changes in fly height can be sensed as changes in output, so actual HDDs control the fly height by sensing the changes in fly height from any changes in output of servo signal, or position error signal (PES). In this control method, however, since the absolute value of the fly height cannot be detected, correcting any variations in the absolute value of the fly height of each slider due to the possible nonuniformity of slider workmanship may be difficult. Accordingly, an alternative scheme not depending upon reading the changes in output is used to correct the absolute fly height of the slider. The alternative scheme referred to here is: affixing a piezoelectric element to the slider; and, after intentionally bringing the slider into contact with the magnetic-recording medium to such an extent that normal reliability is maintained, setting the fly height with the contact position as a starting point of the correction.

The above fly height is controlled to a level at which fly height control becomes difficult to provide by controlling the balance between the rigidity of an air-stream formed between the slider and the magnetic-recording disk 32, and spring rigidity of a suspension attached to the head-slider. In recent years, therefore, a method has been applied that utilizes the thermoelastic deformation, which causes local protrusion, of the magnetic-recording-head elements due to electrical heating of a heater for a thin-film magnetic-recording head in which the magnetic-recording-head elements are simultaneously formed in the neighborhood of the read/write element portion and in a region of the head-slider configured for juxtaposition with the magnetic-recording medium.

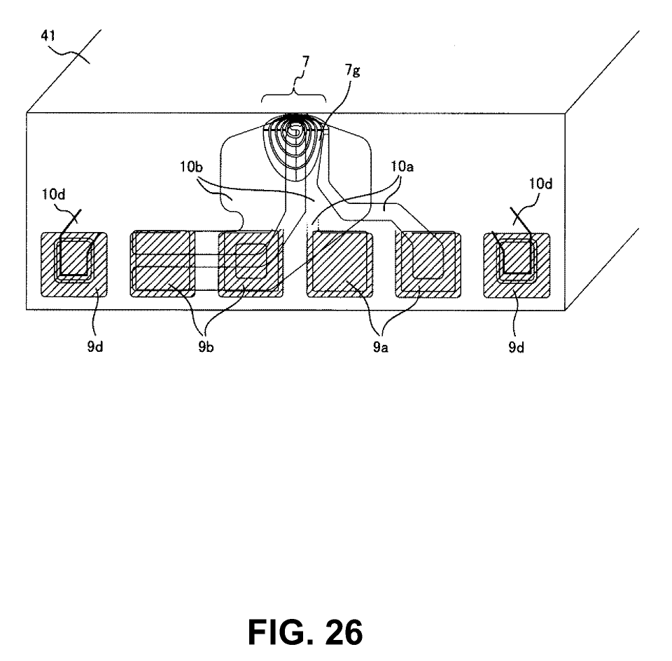

With reference now to FIG. 26, with relevance for embodiments of the present invention, a schematic layout view is shown that shows elements of a thin-film magnetic-recording head having such a heater. This figure is a schematic representation of the planar shape and electrode terminals of the thin-film magnetic-recording head, shown at the edge of a slider substrate with an ABS 41 provided as an upper face. In the neighborhood of the ABS, a read/write element portion 7 is shown with a conductor coil 7g that forms part of the elements. These read/write elements each requiring independent electrical connection to a signal-processing section are connected to electrode pad arrays 9a and 9b near the slider end via interconnect patterns 10a and 10b, respectively. After being passed through an electrical conducting region formed in the HAA 33 shown in FIG. 25, read/write electrical signals are guided into the signal-processing circuit via the above-described electrode pad arrays 9a and 9b. FIG. 26 also shows electrode pads 9d formed externally to the electrode pads 9a and 9b for the read/write elements. The pads 9d are connected to both terminals of the heater via the interconnect patterns 10d.

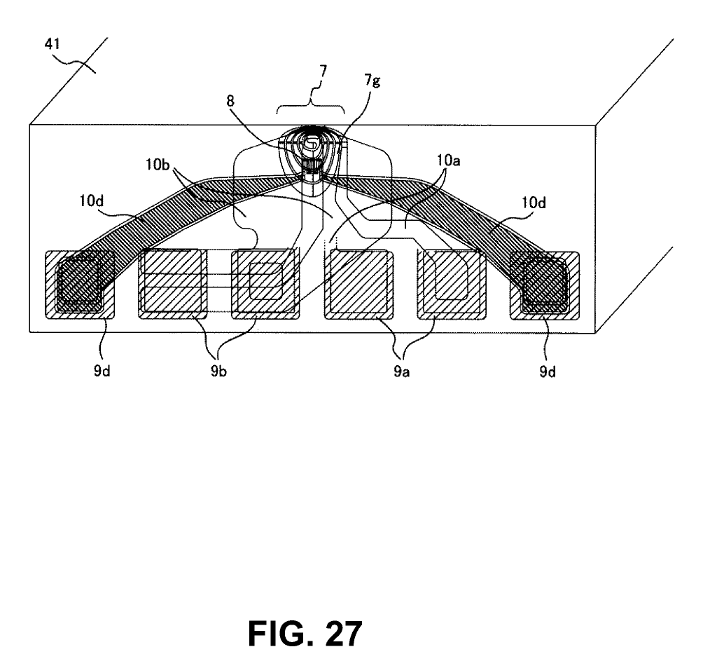

With reference now to FIG. 27, with relevance for embodiments of the present invention, a schematic layout view is shown that further shows the heater and interconnect patterns of the heater 8 in a perspectively overlapped fashion. The figure shows an example in which the heater 8 is formed at the rear of the read/write element portion 7. The interconnect patterns 10a, 10b, and 10d are formed via an insulating layer, and the interconnect patterns are not in contact with one another.

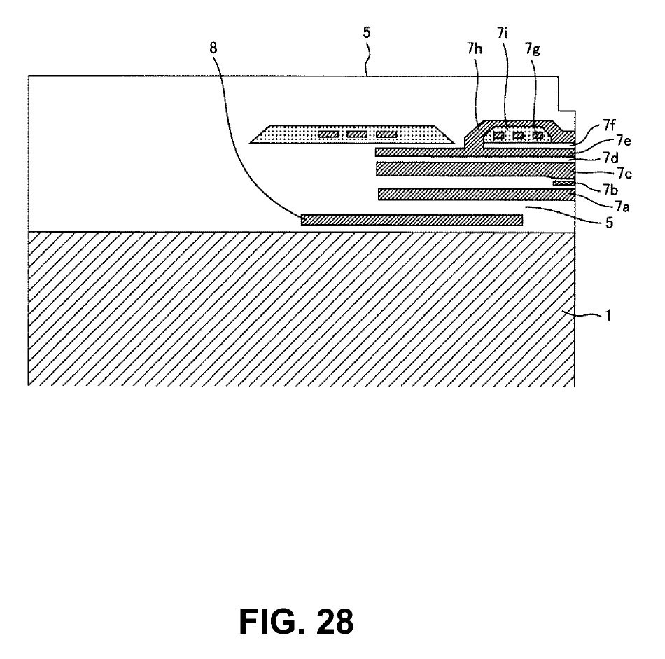

With reference now to FIG. 28, with relevance for embodiments of the present invention, a cutaway view of the above-described thin-film magnetic-recording head including the read/write element portion and heater is shown as viewed from a transverse direction of the read/write element portion (elements 7a-7i) and heater 8. As shown in FIG. 28, the heater 8 is formed at an immediately upper section neighboring the substrate 1. Also, the insulating layer 5 of alumina or similar insulating material, the read elements 7a to 7c, a separating layer 7d, the write elements 7e to 7h, and a protective insulating layer 5 are formed sequentially as deposited thin-film layers formed above the heater 8, which are included in the thin-film magnetic-recording head that includes heater 8. Applying a current to the heater 8 makes the neighborhood of the read/write elements protrude towards the ABS by the exothermic effect of the heater, which narrows the spacing with respect to the magnetic-recording disk 32 disposed in proximity with the ABS in an effective fashion, and reduces the fly height. This method, which allows sufficiently controllable changes in the fly height to be obtained in a thermoelastic deformation range, is a method that is effectively applied in conventional flying-height control technology.

The absolute fly height, however, is difficult to identify with such a method alone, so a standard is required. The implementation of the standard is possible by establishing contact between the slider and the magnetic-recording disk 32, as in the above-described method. The detection of the contact between the slider and the magnetic-recording disk 32 is useful to the control of the fly height; and, the enhancement of contact detection accuracy is a challenge for increasing the recording density of the HDD. As discussed above, detection by an AE sensor including a piezoelectric element may be currently the most accurate of all applicable methods; and, the AE sensor is utilized as a suitable device in the characterization of components. The fact is, however, that existing AE sensors are still confined to applications as characterization devices, because mounting such an existing AE sensor in a HDD increases manufacturing costs of the HDD; and, existing AE sensors may not be reliable enough for use in HDD product. Although various methods of detecting contact are applied in current HDDs, the application of each existing method is confined to detecting the changes in servo signal and PES states, as described above. Thus, embodiments of the present invention provide an increase in contact detection accuracy that is suitable for future enhancement of recording densities.

Embodiments of the present invention are intended to provide a thin-film magnetic-recording head configured to provide highly accurate detection of the contact between the head-slider and the magnetic-recording medium. Embodiments of the invention are also intended to use a heater element to control, including any variations in fly height between magnetic-recording heads, the small fly height of the particular slider between the read/write element portion and the magnetic-recording medium to a constant level with the contact position taken as a starting point of the control. In addition, embodiments of the invention are intended to further increase recording density of a HDD which utilizes a magnetic-recording head including a built-in AE sensor.

As described above, a piezoelectric element or an AE sensor including the piezoelectric element is effective for detecting the contact with the magnetic-recording medium; and, an example of affixing the piezoelectric element to the slider from the outside is disclosed. In terms of reliability and the mass-productivity including the machine cycle time required, however, this conventional method includes a number of uncertain factors, and, to the inventors' knowledge, has not yet been put into practical use. In addition, for example, attempts to implement integration of the AE sensor with the magnetic-recording head by forming the piezoelectric element in the slider substrate are disclosed. In this example, the piezoelectric element itself is disposed in the form of a cushion and used as the substrate of the magnetic-recording head element; and, this method is characterized in that a deformation effect is obtainable by utilizing the electrostrictive effect of the piezoelectric element. The corresponding method is based upon a concept inverse to a technique for distributing deformation-based flying control, tracking control, and other functions to devices each having a single function, the method being characterized in that the substrate has all these functions. In current HDDs, however, the increase in overall performance is difficult without the best configuration for each such function; and, the distribution of the functions is therefore considered to be a useful for further increases in performance. Furthermore, the configuration with the read/write element portion formed on the piezoelectric element, because the configuration occupies a wide area, may cause noise to be superimposed upon the magnetic-recording head signals during driving the piezoelectric element, and to adversely affect the waveforms of the read/write signals. The configuration with the read/write element portion formed on the piezoelectric element raises numerous issues to be addressed before the configuration with the read/write element portion formed on the piezoelectric element can be placed in practical use.

One issue that embodiments of the present invention may address is how to construct a magnetic-recording head at minimum cost, and consequently render this magnetic-recording head applicable to a HDD. Embodiments of the present invention apply integrated-circuit (IC) process technology and form a piezoelectric-element-based AE sensor integrally with a heater and a read/write element portion of the magnetic-recording head to ensure that a known technique for detecting contact between a slider and a magnetic-recording head by utilizing a piezoelectric element is incorporated into the magnetic-recording head and HDD actually used. Another issue that embodiments of the invention address is how to reduce driving voltage of the AE sensor and enable lower-noise and higher-sensitivity operation. Addressing these issues, in accordance with embodiments of the present invention, makes realizable: a substrate on which a piezoelectric element is easily manufactured; a substrate in which an AE sensor is integrally formed that can be operated with low driving voltage and minimal noise level; and, a substrate from which a slider is diced that gives reality to a magnetic-recording head capable of detecting contact and shocks with high accuracy.

Embodiments of the present invention provide a thin-film magnetic-recording head configuration in which a thin-film AE sensor including a piezoelectric element is formed on an electrically conductive substrate. Embodiments of the present invention also provide, after the AE sensor has been shrouded with an insulating layer on the wafer substrate, a heater and a read/write element portion of the magnetic-recording head integrally formed with IC technology. Embodiments of the present invention further provide a terminal at one side of the AE sensor that is connected to the substrate and in a grounded connection. In accordance with embodiments of the present invention, the AE sensor is formed near a magnetic-recording medium-facing slider surface as a means to increase contact detection sensitivity and accuracy. In addition, in accordance with yet other embodiments of the present invention, AE sensors may be formed in a plurality of places such that these sensors may be connected in parallel to further increase contact detection sensitivity.

In accordance with embodiments of the present invention, using the electrically conductive substrate as the grounding terminal for the thin-film AE sensor facilitates the fabrication process for the substrate, making it unnecessary to affix the piezoelectric element from the outside, and thus enhancing mass-productivity. In addition, in accordance with embodiments of the present invention, since the driving voltage of the AE sensor can be reduced, electric power to be supplied can be reduced and the noise level can be lowered for increased contact detection sensitivity and accuracy. Thus, embodiments of the present invention allow energy savings in the HDD and are effective as a preventive measure against global warming. In accordance with embodiments of the present invention, constructing the magnetic-recording head on this substrate and using the slider separated by dicing from the substrate provides a magnetic-recording head-slider including the thin-film AE sensor. In accordance with embodiments of the present invention, since the AE sensor noise level is low, adverse effects upon the magnetic-recording head may also be suppressed. Thus, in accordance with embodiments of the present invention, the magnetic-recording head operates in linked form with a separately built-in heater for fly height control to provide stable control of the small fly height, because the contact position with the magnetic-recording medium is taken as a reference. Moreover, in accordance with embodiments of the present invention, variations in fly height between magnetic-recording heads can therefore be reduced; and, thus, stable head characteristics can be realized. In accordance with embodiments of the present invention, the head-slider that is formed by integrating the read/write element portion of the magnetic-recording head, the heater, and the AE sensor is constructed so that the performance of each of read/write element portion of the magnetic-recording head, the heater, and the AE sensor may be fully utilized.

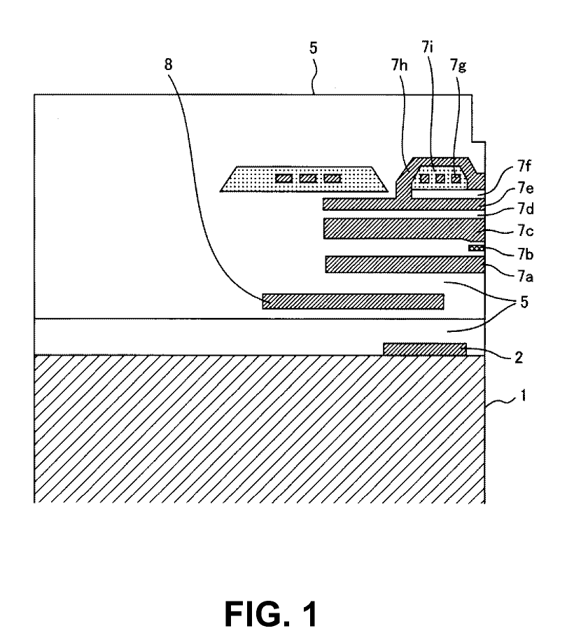

With reference now to FIG. 1, in accordance with an embodiment of the present invention, a schematic cross-sectional view is shown of an AE sensor, heater, and thin-film magnetic-recording head element region at a neighboring section of an ABS for a slider. As shown in FIG. 1, a substrate 1 of the slider is formed from an electrically conductive body, and a thin-film AE sensor 2 is formed directly upon the substrate 1 by deposition. Since the AE sensor is formed in this way, the substrate 1 also functions as an electrical grounding element for one electrode of the AE sensor. After the formation of the AE sensor 2, an insulating layer 5 of alumina, or similar material, is formed in film form and planarized. The heater 8, another insulating layer 5, read elements 7a to 7c, a separating layer 7d, write elements 7e to 7h, and a protective insulating layer 5 are formed upon the planarized insulating layer 5 by repeating sequential film deposition and patterning to form a thin-film magnetic-recording head that includes the thin-film AE sensor and the heater.

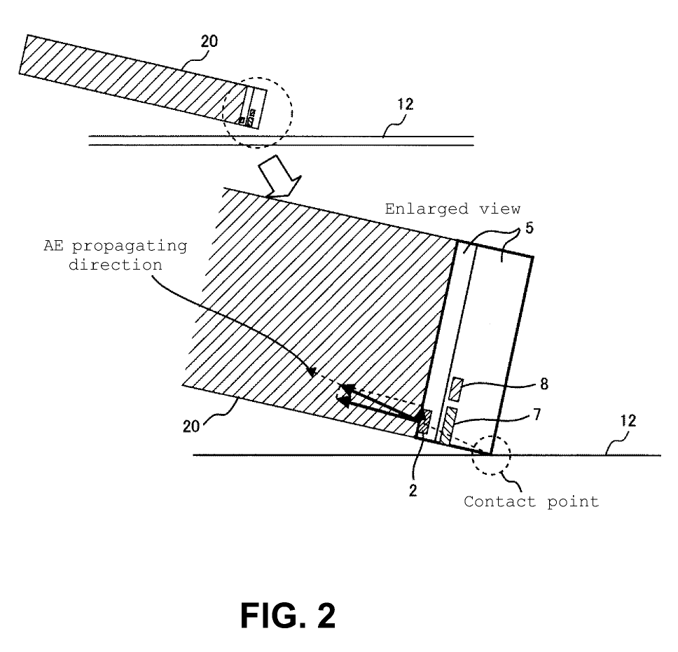

With reference now to FIG. 2, in accordance with an embodiment of the present invention, a schematic diagram is shown that represents slider flying, and making contact with a magnetic-recording disk 12. In this figure, the slider 20 is juxtaposed to the magnetic-recording disk 12 at a distal end of the slider 20 with a slight clearance, which is identified with the fly height, the distal end being formed with the read/write element portion denoted by a dotted line. Referring to the enlarged diagram of the distal end that is shown at a lower right side of FIG. 2, the AE sensor 2, the read/write element portion 7, and the heater 8 are formed at the distal end of the slider 20 via an insulating body of alumina or similar material. For example, when an exothermic effect on the heater 8, which is brought on by supply of electric power to the heater 8, brings the slider 20 into contact with the magnetic-recording disk 12 at a location of contact, indicated by the dashed-line circle in FIG. 2, an elastic wave propagates through the slider from that contact position as a starting point. This elastic wave propagates in a direction of an arrow with respect to the AE sensor 2. Depending upon a vectorial distribution rate between a film-thickness direction, which is a polarizing direction, of the AE sensor 2 and a direction orthogonal to the film-thickness direction, the elastic wave is converted into an electric signal by the sensor itself; and, thus, contact is detected. Contact detection sensitivity increases with decreasing distance from the contact position, and with increasing vector components in a polarizing direction of a piezoelectric element, which forms the AE sensor. In one embodiment of the present invention, the sensor is formed close to the slider section opposed to the ABS, and in a region where the slider is most likely to come into contact with the magnetic-recording disk 12. In another embodiment of the present invention, the sensor is disposed in the head-slider taking into account the arrangement of components in the HDD from a comprehensive viewpoint with due consideration of the read/write element portion, heater, fly height setting, mechanical features, as well as other design factors. Disposing the AE sensor in an appropriate location of the head-slider also allows monitoring for unusual contact between the magnetic-recording head and the magnetic-recording disk 12.

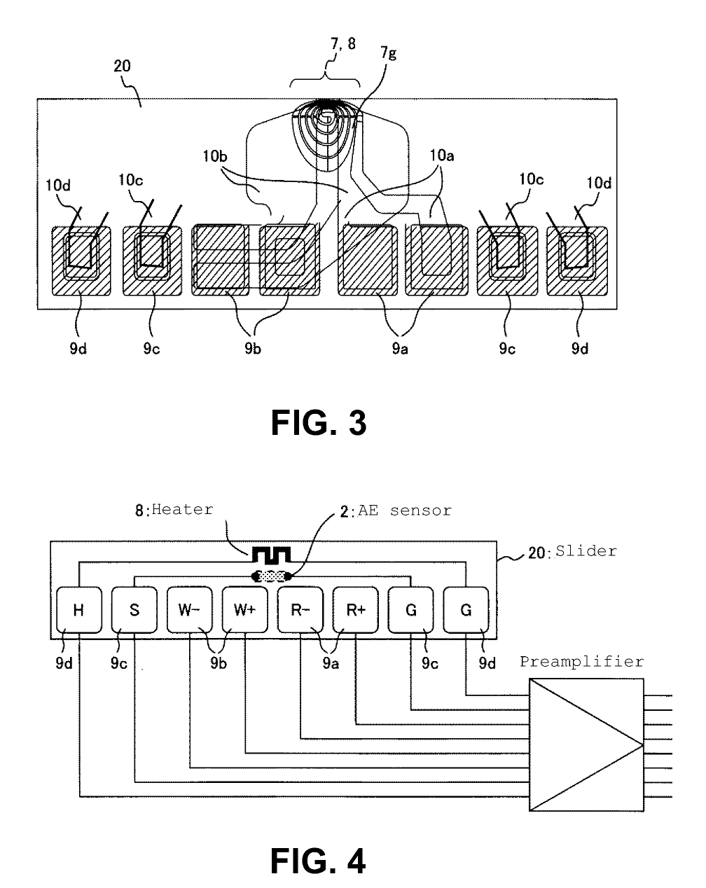

With reference now to FIG. 3, in accordance with an embodiment of the present invention, a schematic diagram is shown that shows an example layout of the thin-film AE sensor, heater, read/write element portion, and electrode pads. Also, FIG. 4 is a schematic diagram of the distal-end planar section of the slider 20, and is also a diagram that shows output routes of various electrical signals of the thin-film magnetic-recording head including the thin-film AE sensor and the thermal fly-height control (TFC) heater 8.

With reference now to FIG. 4 and further reference to FIG. 3, in accordance with an embodiment of the present invention, the electrode pads 9c and interconnect patterns 10c of the AE sensor 2 are arranged externally to the slider. This arrangement allows for the following effect. That is to say, even if the AE sensor, a device added to the electrode pad array in the conventional example shown in FIGS. 26 and 27, adversely affects the read/write element portion 7, spacing the AE sensor signal line as far as possible from the read/write signal lines will be effective as a certain preventive measure that mitigates adverse effects on the read/write element portion 7. The pads 9a in FIG. 4 are electrodes for the read elements, and the pads 9b are electrodes for the write elements, each of the two kinds of pads being independently connected to a preamplifier provided outside the HAA. The pads 9d are for the heater 8, and the pads 9c are electrodes for the added AE sensor 2. As shown in FIG. 4, one of the two paired pads 9c, 9d, in the example, is connected to the grounding element, thus ensuring stable signal quality.

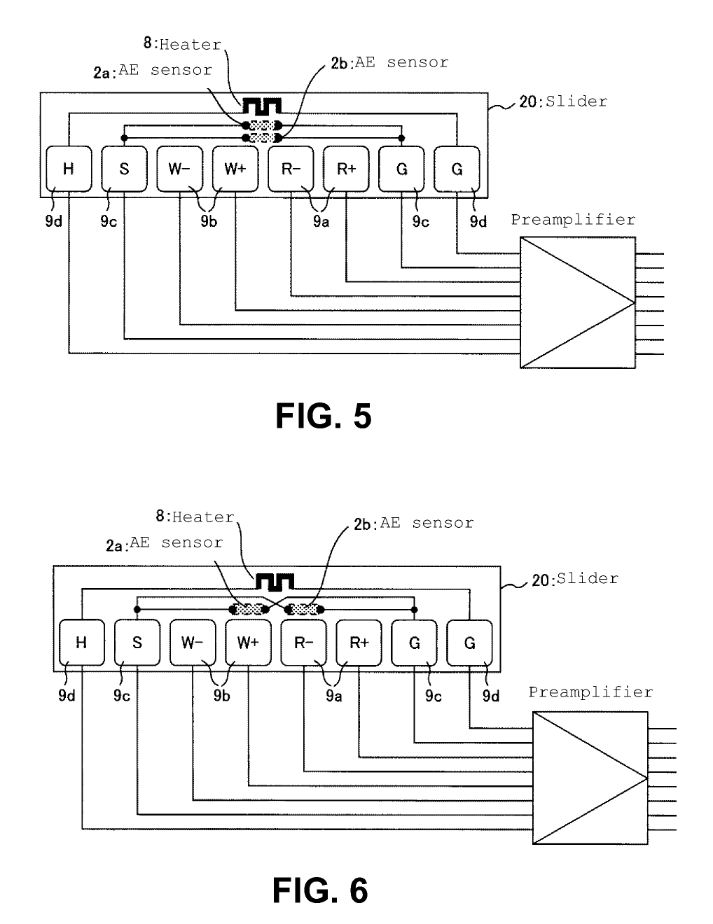

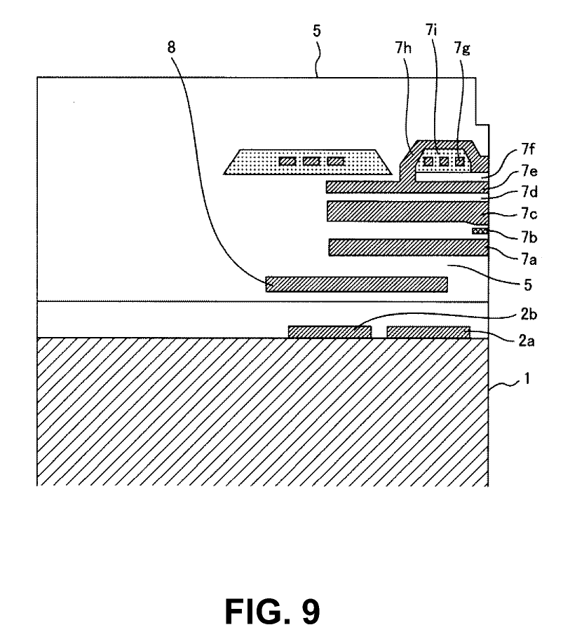

With reference now to FIGS. 5 and 9, in accordance with an embodiment of the present invention, schematic representations are shown of an example in which two thin-film AE sensors are formed. These figures show an example in which AE sensors 2a and 2b, similar to the AE sensor 2 shown in FIG. 1, are formed in two places in a depthwise direction below the ABS.

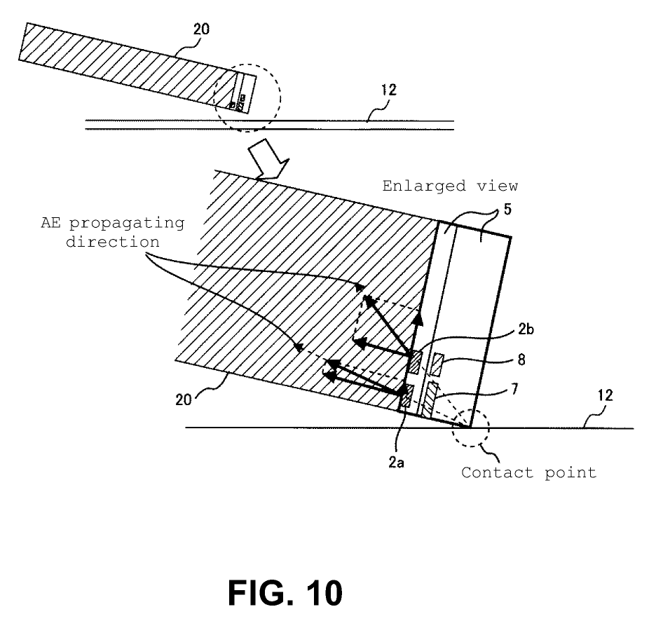

With reference now to FIGS. 9 and 10, in accordance with an embodiment of the present invention, in FIG. 10, a schematic diagram is shown that represents a slider flying, and in contact with, the magnetic-recording disk 12; FIG. 10 is described in association with the second schematic cross-sectional view of the AE sensor, heater, and thin-film magnetic-recording head element region at a neighboring section of the ABS of the slider shown in FIG. 9. In FIG. 10, the slider 20 at a distal end of the slider 20 is juxtaposed to the magnetic-recording disk 12 with a slight clearance, which is the fly height, such that the distal end is formed with the read/write element portion denoted by the hatched rectangle. Referring to the enlarged diagram of the distal end that is shown at a lower right side of FIG. 10, the AE sensors 2a and 2b, the read/write element portion 7, and the heater 8 are formed at the distal end of the slider 20 along with insulating alumina, or similar insulating material. For example, when an exothermic effect of the heater 8 caused by supply of electric power to the heater 8 brings the slider 20 into contact with the magnetic-recording disk 12 within the dashed-line circle, elastic waves propagate through the slider in conjunction with that contact position as a starting point. These elastic waves propagate in directions of arrows with respect to the AE sensors 2a and 2b. Depending upon a vectorial distribution rate between a film-thickness direction, which is a polarizing direction, of the AE sensors 2a and 2b and a direction orthogonal to the film-thickness direction, the elastic waves are converted into electric signals by the sensors, and both signals are summed for contact detection. Thus, in accordance with an embodiment of the present invention, detection efficiency can be increased over that attainable with the single-sensor configuration. Contact detection sensitivity increases with decreasing distance from the contact position, and with increasing vector components in a polarizing direction of a piezoelectric element which forms the AE sensor. In another embodiment of the present invention, the AE sensors are formed at positions near the slider section opposed to the ABS, in a region that makes the slider most likely to come into contact with the magnetic-recording disk 12. Moreover, in another embodiment of the present invention, the two AE sensors 2a and 2b are disposed as close as possible to each other. In this case, however, the AE sensors 2a and 2b are also disposed from an overall viewpoint of the HDD taking into account the read/write element portion, heater, fly height setting, mechanical features, as well as other design factors.

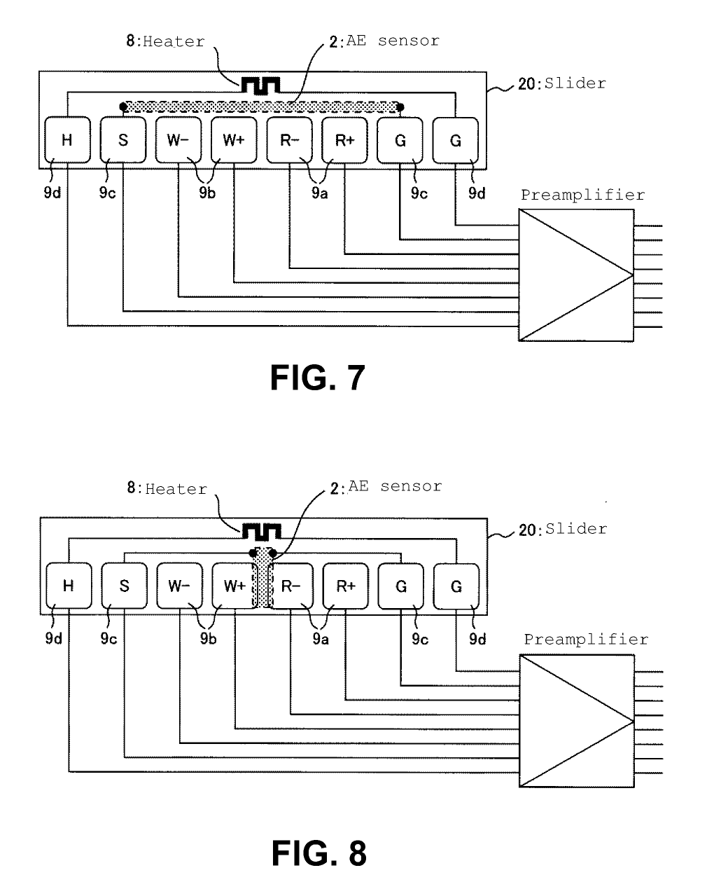

In accordance with another embodiment of the present invention, another method may be used to form a plurality of AE sensors. One effective method, for example, is by arranging a plurality of AE sensors in a region neighboring the ABS, in a direction along an electrode pad array, which corresponds to a minor-axis direction of the slider. In this case, since the AE sensors can be arranged for a minimum difference in elastic wave propagation distance with respect to the sensors, further enhancement of contact detection sensitivity and accuracy is anticipated (see FIG. 6). Various other possible methods include those shown in FIGS. 7 and 8. For example, as shown in FIG. 7, the planar shape of one AE sensor can be rectangular with its longer side formed in the minor-axis direction of the slider; or alternatively, as shown in FIG. 8, the planar shape of one AE sensor can be rectangular with its longer side formed in the thickness direction of the slider, which is in a depth-wise direction from the ABS. The arrangement of the AE sensors in both of the latter two cases takes into consideration the overall viewpoint of the design of the HDD.

### First Example

In accordance with other embodiments of the present invention, examples of a wafer and slider are next described using the accompanying drawings.

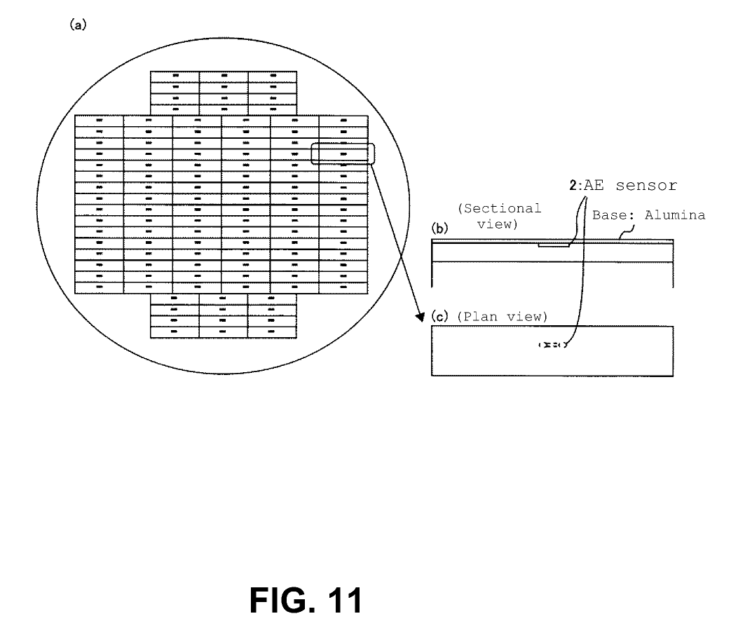

With reference now to FIG. 11(a), in accordance with an embodiment of the present invention, schematic view is shown of an example of layout of a wafer substrate on which a thin-film AE sensor has already been fabricated. The thin-film AE sensor in the figure is deposited so that when magnetic-recording head-sliders are diced from the wafer substrate, a sensor will be formed in each of the sliders. After the formation of the thin-film AE sensor, the wafer is fabricated: with an insulating protective layer, such as alumina; with an electrically conductive stud formed up to a neighboring section of the wafer surface to provide electrical continuity to the AE sensor; and, with the wafer surface further planarized. Thus, in accordance with embodiments of the present invention, a technique utilized in a normal manufacturing process for thin-film magnetic-recording heads may be used to fabricate thin-film magnetic-recording heads including built-in AE sensors. FIG. 11(b) is a cross-sectional view of each slider chip; and, FIG. 11(c) is a plan view of each slider chip.

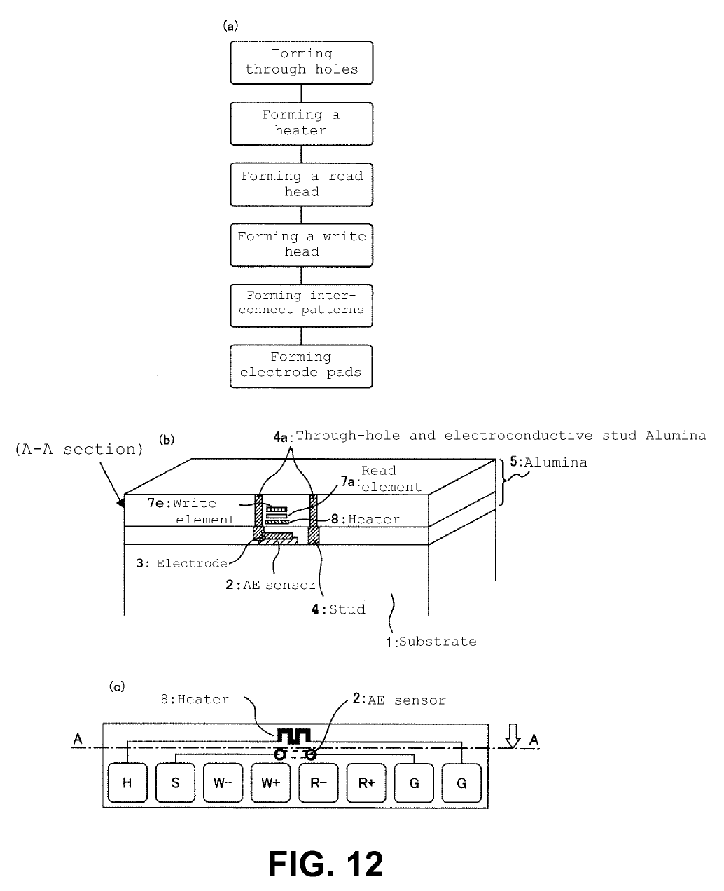

With reference now to FIGS. 12(a), 12(b) and 12(c), in accordance with an embodiment of the present invention, schematic diagrams show a manufacturing process for a thin-film magnetic-recording head which uses the wafer substrate having the thin-film AE sensor fabricated as described above in FIGS. 11(a), 11(b) and 11(c). As described above, the stud 4 for providing electrical continuity is formed in advance both at an upper electrode 3 of the AE sensor 2 and on the substrate 1. Therefore, an electrically conductive through-hole and stud 4a are first formed for connection to the stud 4. Next, a heater 8, read elements 7a to 7c, write elements 7e to 7h, and insulating protective alumina layers are formed by deposition. After this, patterns for interconnection between each element of the thin-film magnetic-recording head and electrode pads are formed; and, then, the electrode pads are fabricated to complete the process. FIG. 12(c) is a pictorial representation of the distal-end planar region of the slider 20, also showing the arrangement of the electrode pads. FIG. 12(b) shows a cross-sectional view through section A-A of the distal-end planar region.

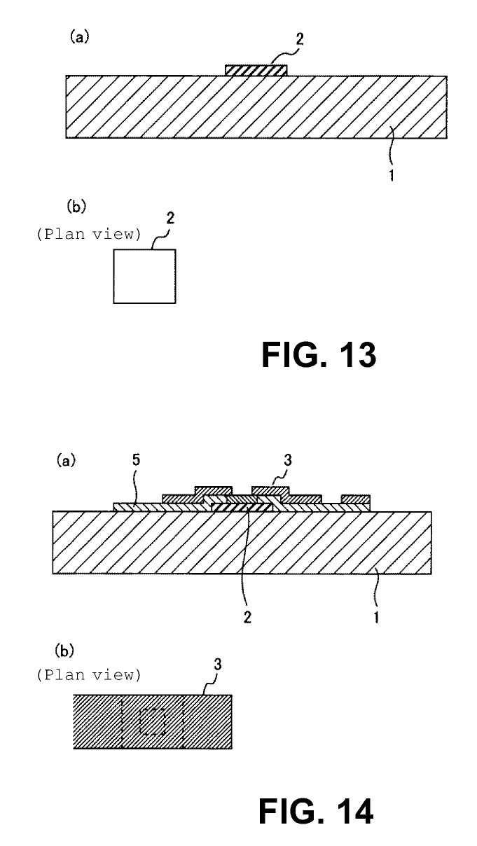

With reference now to FIGS. 13 through 19, in accordance with embodiments of the present invention, an example of a deposition process for fabricating the thin-film AE sensor is next described.

FIGS. 13(a) and 13(b) show the operation of forming the AE sensor on the substrate. The AE sensor 2 including a piezoelectric element is formed on the electrically conductive substrate 1 formed from alumina titanium carbide (AlTiC), for example. The AE sensor 2 is polarized in a thickness direction of the substrate.

FIGS. 14(a) and 14(b) show the operation of creating an electrode 3 patterned together with an insulating layer 5 of alumina or similar insulating material, at an upper section of the AE sensor 2.

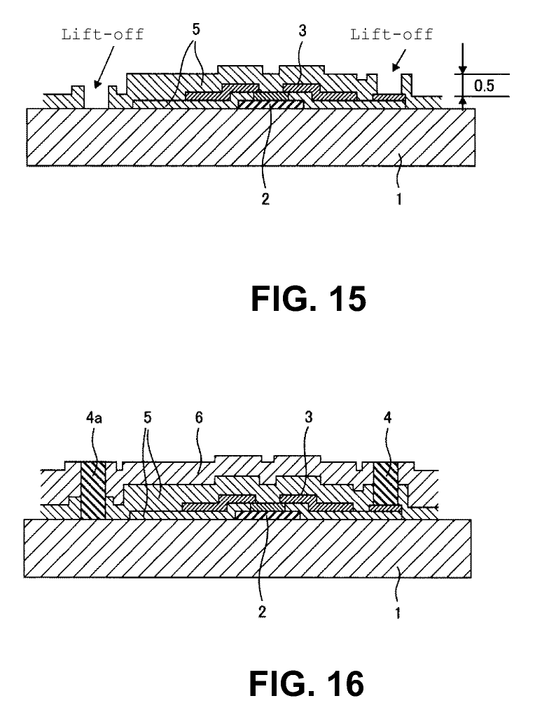

FIG. 15 shows an operation in which, after the surface has been covered with an insulating layer 5 of alumina or similar insulating material, a through-hole for forming a stud to function as a conducting terminal is formed using existing IC technology such as a lift-off process.

FIG. 16 shows the operation of creating the stud 4 having a metallic body formed in the through-hole. The electrically conductive stud 4 connects at one side of electrically conductive stud 4 to the electrode 3 formed at the upper section of the AE sensor 2. Another stud 4a directly connects to the electrically conductive substrate 1. Photoresist 6 covers the surface including the studs 4 and 4a. The AE sensor 2 is polarized in the thickness direction of the AE sensor 2.

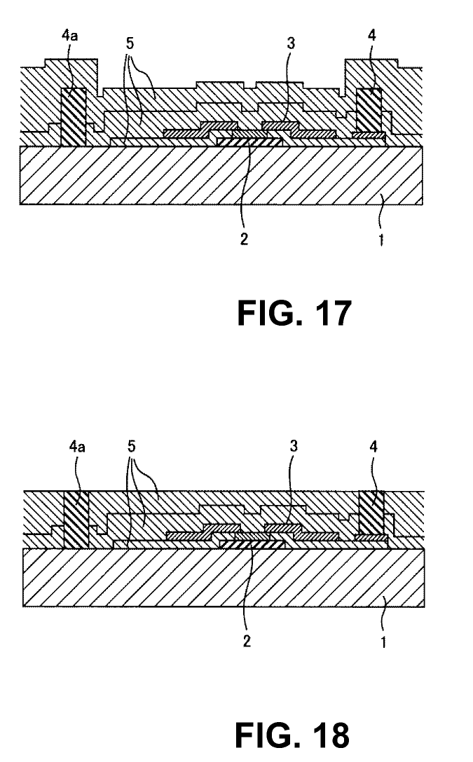

FIG. 17 shows the operation of covering the surface with the insulating layer 5 of alumina or similar insulating material.

FIG. 18 shows the operation of planarizing the surface of the wafer by chemical mechanical polishing (CMP) or a similar planarizing process.

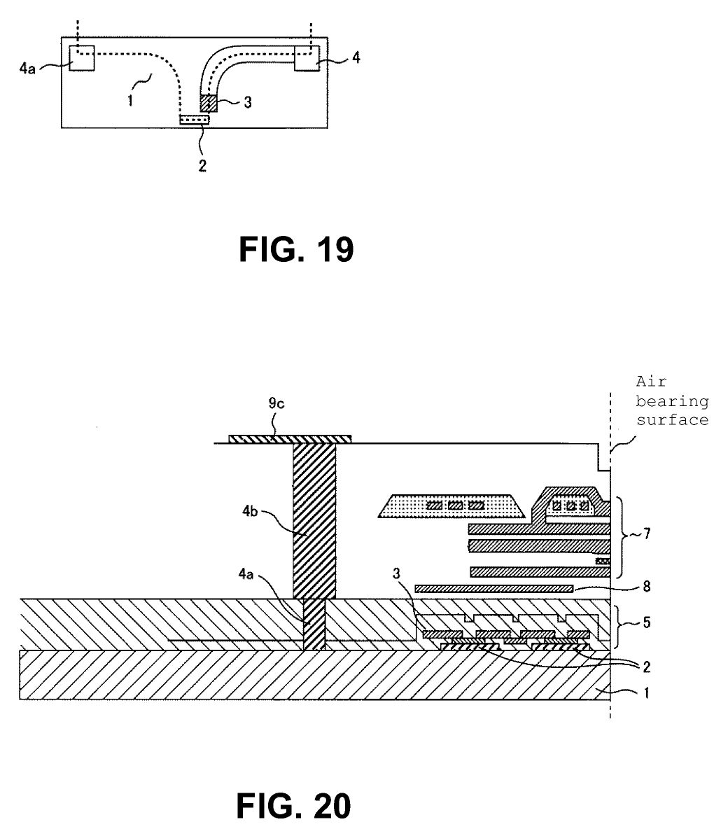

FIG. 19 shows a schematic plan diagram of the planarized slider shown in FIG. 18. A dotted line in FIG. 19, drawn along the cross section of FIG. 18, also shows a flow of a detection current through the AE sensor 2.

In FIGS. 13 to 19, in accordance with embodiments of the present invention, the piezoelectric element can be a piezoelectric ceramic material selected from the group consisting of lead zirconate titanate, barium titanate, and lead titanate. In one embodiment of the present invention, the thickness of the AE sensor is nearly 0.12 micrometers (μm). In another embodiment of the present invention, after an insulating layer 5 of alumina or similar insulating material has been deposited, being disposed on both sides of the AE sensor 2, an electrode 3 is patterned; and, a thickness of the electrode 3 is about 0.13 μm. In another embodiment of the present invention, after this, nearly 0.5 μm of alumina is deposited upon the electrode. In another embodiment of the present invention, the section where a stud 4 is to be disposed is removed by lift-off; and, then, the surface of this section is coated with a photoresist 6 for patterning. Next, in another embodiment of the present invention, the stud 4 and a stud 4a are fabricated by plating to establish electrical continuity. Finally, in another embodiment of the present invention, another insulating layer 5 of alumina or similar insulating material is deposited to cover the surface up to an upper section of the stud 4, with the alumina. Since the surface thus becomes rough, in another embodiment of the present invention, the surface is planarized by CMP until a head of the stud 4 has been exposed. After going through such a process, in another embodiment of the present invention, an electrically conductive substrate that includes a thin-film AE sensor can be fabricated with the stud 4a as a grounding element and the stud 4 as a terminal.

### Second Example

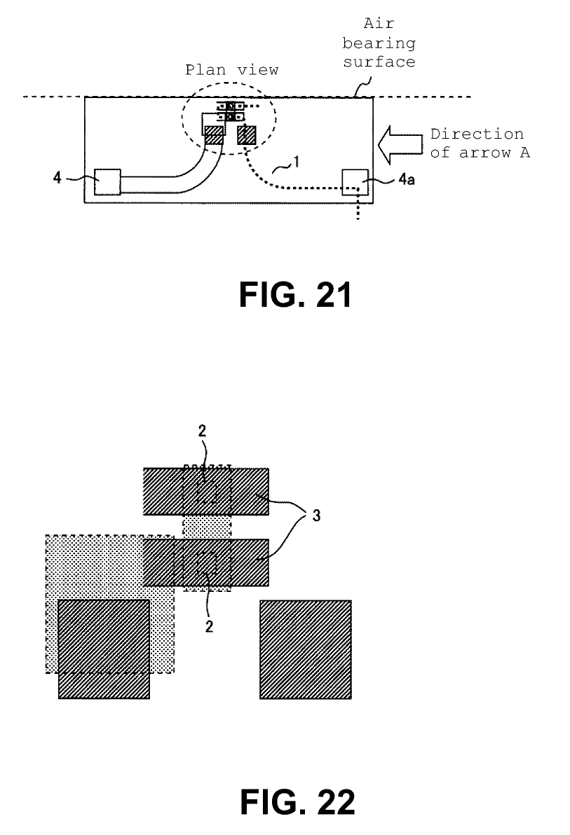

With reference now to FIGS. 20, 21 and 22, in accordance with an embodiment of the present invention, schematic views are shown that show an example of connecting two thin-film AE sensors, and also show a heater and thin-film magnetic-recording head element region present near an ABS. In these figures, two AE sensors 2 are formed in the depthwise direction of the two AE sensors 2 from the ABS, with upper edges of both sensors being interconnected via an electrode 3 and with lower sections of both being connected directly to a grounding element in an electrically conducting form with the substrate 1. The two AE sensors 2 are formed in the same process as the deposition of the above-described thin-film AE sensor of FIGS. 13 through 19. FIG. 20 is a cross-sectional view of the slider and ABS neighboring region as viewed from a direction of arrow A in FIG. 21, which is a schematic plan view of the slider. A dotted line in FIG. 21, extending from a stud 4a to the electrode 3, is a line drawn along the cross section of FIG. 20. In FIG. 20, the stud 4a connected to the substrate is also connected to a stud 4b formed during the manufacture of the thin-film magnetic-recording head, and to an electrode 9c formed on the surface; and, the stud 4a functions as the grounding element and as one AE sensor electrode. FIG. 22 is an enlarged view of the interconnection between the two AE sensors at the ABS neighboring region shown by the round dotted line in FIG. 21.

### Third Example

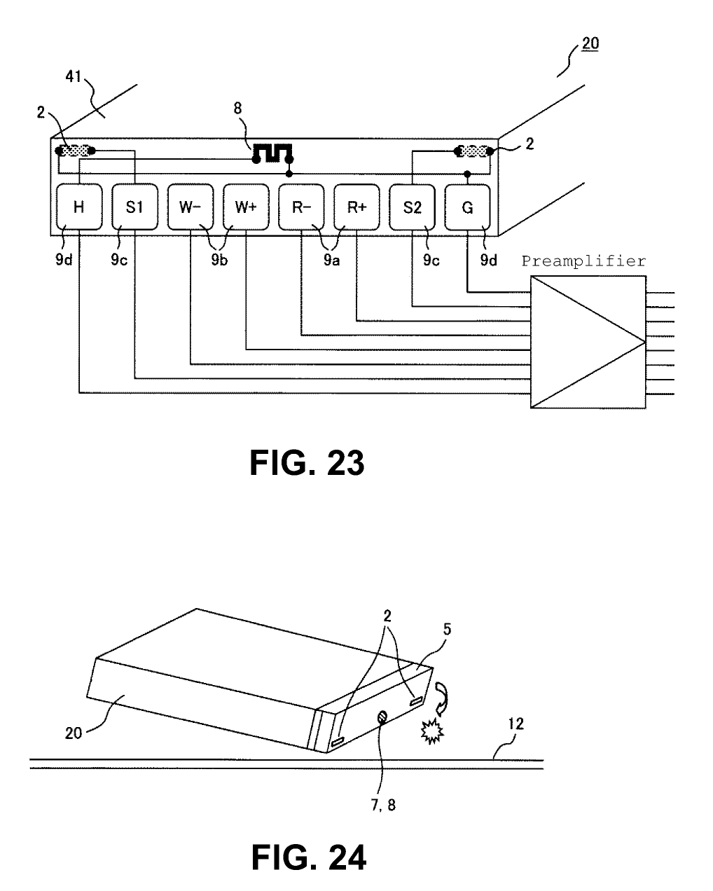

With reference now to FIGS. 23 and 24, in accordance with an embodiment of the present invention, a diagram is shown that shows an example of forming two thin-film AE sensors near an outer edge of a slider in FIG. 23; and, in FIG. 24, a diagram is shown that shows an example of detecting unusual slider contact. FIG. 23 shows a distal-end planar section of a slider 20 as an example in which the thin-film AE sensor of the present invention is formed close to both ends of the slider 20. As shown in the figure, the thin-film AE sensors 2 are formed in a neighboring region of an ABS 41, close to both ends of the slider 20. In the configuration involved, if, as shown schematically in FIG. 23, for example, a slider deviates from its normal flying attitude and one side of the slider comes into unusual contact, for example, as shown in FIG. 24, with the magnetic-recording disk, this state can be detected from a difference in propagation time between elastic waves from the contact position. The configuration of the two thin-film AE sensors 2 facilitates detection of an abnormal slider to discontinue use of the abnormal slider, which is expected to prevent inclusion of defective sliders in the HDD. In addition, considering a combination with the above-described heater 8 allows fly-height correction of the slider in unusual contact, as shown in FIG. 24. Various other effects that may also contribute to increasing the performance and reliability of the HDD are anticipated by considering the arrangement of the thin-film AE sensors shown in FIG. 23.

### INDUSTRIAL APPLICABILITY

Embodiments of the present invention can be applied to magnetic-recording heads built into HDDs. Embodiments of the present invention can also be applied to certified-heads for protrusion detection and inspection of media.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A thin-film magnetic-recording head, comprising:
a read/write element portion;
at least one built-in thin-film acoustic-emission sensor; and
a heater;
wherein said read/write element portion, said thin-film acoustic-emission sensor and said heater are integrally formed in proximity to a face of an electrically conductive slider substrate over which said read/write element portion, said acoustic-emission sensor and said heater are formed, with said face of said slider substrate configured for being disposed opposite to a magnetic-recording medium of a magnetic-recording disk, near an air-bearing surface formed on a surface of said slider substrate.

2. The thin-film magnetic-recording head of claim 1, further comprising:
a plurality of thin-film acoustic-emission sensors, said plurality of thin-film acoustic-emission sensors formed in a single process.

3. The thin-film magnetic-recording head of claim 2, wherein said plurality of said thin-film acoustic-emission sensors are formed next to each other, in a depthwise direction below said air-bearing surface.

4. The thin-film magnetic-recording head of claim 2, wherein said plurality of said thin-film acoustic-emission sensors are formed next to each other, near said air-bearing surface and in a minor-axis direction of said slider substrate.

5. The thin-film magnetic-recording head of claim 2, wherein said plurality of said thin-film acoustic-emission sensors are formed next to each other, near said air-bearing surface and neighboring an outer end of said slider substrate.

6. The thin-film magnetic-recording head of claim 1, wherein said slider substrate comprises an electrically conductive substrate body, and a terminal at one side of said thin-film acoustic-emission sensor is grounded by connecting directly to said electrically conductive substrate body.

7. The thin-film magnetic-recording head of claim 1, wherein said thin-film acoustic-emission sensor is formed on said slider substrate, and said heater and said read/write element portion are formed above said thin-film acoustic-emission sensor in an order of said heater, first, and said read/write element portion, second.

8. The thin-film magnetic-recording head of claim 1, wherein said thin-film acoustic-emission sensor comprises a piezoelectric element subjected to polarization in a thickness direction of said slider substrate.

9. The thin-film magnetic-recording head of claim 8, wherein the piezoelectric element comprises a piezoelectric ceramic material selected form the group consisting of lead zirconate titanate, barium titanate, or lead titanate.

10. The thin-film magnetic-recording head of claim 1, wherein said thin-film magnetic-recording head is configured to use said thin-film acoustic-emission sensor to detect contact between said slider substrate and a magnetic-recording disk comprising said magnetic-recording medium, said magnetic-recording head being further configured to use said heater to control fly height between said slider substrate and said magnetic-recording disk with a contact position between said thin-film magnetic-recording head and said magnetic-recording disk serving as a starting point for said control.

11. A hard-disk drive, comprising:
a thin-film magnetic-recording head, comprising:
a read/write element portion;
at least one built-in thin-film acoustic-emission sensor; and
a heater;
wherein said read/write element portion, said thin-film acoustic-emission sensor and said heater are integrally formed in proximity to a face of an electrically conductive slider substrate over which said read/write element portion, said acoustic-emission sensor and said heater are formed, with said face of said slider substrate configured for being disposed opposite to a magnetic-recording medium of a magnetic-recording disk, near an air-bearing surface formed on a surface of said slider substrate.
